(19) United States
(12) Patent Application Publication
(10) Pub. No.: US 2010/0156126 A1
(43) Pub. Date: Jun. 24, 2010

(54) MODULAR SHOVEL FOR USE WITH AN ADAPTER ASSEMBLY

(75) Inventors: David Trachet, Onstead, MI (US); Richard Hamann, Salina, MI (US)

Correspondence Address: YOUNG BASILE, 3001 WEST BIG BEAVER ROAD, SUITE 624, TROY, MI, 48084, US

(73) Assignee: Syron Engineering & Manufacturing, LLC

(21) Appl. No.: 11/909,360

(22) PCT Filed: Mar. 14, 2006
(86) PCT No.: PCT/US06/09123

§ 371 Date: Mar. 12, 2010

Related U.S. Application Data
(60) Provisional application No. 60/664,413, filed on Mar. 23, 2005.
(60) Provisional application No. 60/749,498, filed on Dec. 12, 2005.

(51) Int. Cl. B25J 15/00; B66C 1/62; B66C 1/44; B25J 17/00; B25J 18/00; B23Q 3/00

(52) U.S. Cl. 294/92; 74/490.05; 294/106; 901/28; 901/39

(57) ABSTRACT

An adapter device (26) for use in automated handling equipment (10) includes an adapter support (30) that is adapted for automated movement. One or more support members (32) are rigidly securable to the adapter support (30) in a plurality of different positions relative to the adapter support (30) to provide a variety of adapter device (26) configurations for objects of different sizes and shapes.

### RELATED APPLICATIONS

This application claims priority to Provisional Application 60/664,413 filed on Mar. 23, 2005, and Provisional Application 60/749,498 filed on Dec. 12, 2005.

### BACKGROUND OF THE INVENTION

The present invention relates generally to automated handling equipment and, more particularly, to an adapter for handling objects during movement.

Automated handling equipment, such as a robotic arm or a transfer press assembly, is often employed in an industrial setting to move objects between stations. For example, a metal component is stamped in a first stamping press and then transferred to a second stamping press for a second stamping. To achieve high cycle times, the automated handling equipment must move the object quickly and accurately. Typically, the automated handling equipment includes an adapter or an actuated gripper that supports the object during movement.

A conventional adapter assembly includes a shovel that engages and supports the object during movement. Typically, the shovel is custom-made to correspond to the particular shape and size of the object. For example, the shovel may include various extended portions that are welded in a desired arrangement to a base portion. The relative positions of the extended portions correspond to the shape and size of the object to securely support the object upon engagement.

Undesirably, conventional welded custom-made shovels are designed to support the specific size and shape of the particular object. If a different object is to be moved, the shovel needs to be removed and replaced with a different shovel that is custom-made for the shape and size of the different object. This adds expense and complexity to the manufacturing process, and a large number of shovels are needed for transferring different objects.

Accordingly, there is a need for a modular shovel that is adjustable to accommodate objects of different shapes and sizes.

### SUMMARY OF THE INVENTION

One example adapter device for use in automated handling equipment includes an adapter support that is adapted for automated movement. A support member is rigidly securable to the adapter support in more than one position relative to the adapter support to provide a variety of adapter device configurations suitable for supporting objects of different sizes and shapes.

One example includes a mount for connecting an adapter device to a robotic member of an automated handling system. The mount is rigidly securable to either the robotic member or the adapter support in more than one mount position to provide a variety of configurations. This allows reconfiguration of the adapter device and mount to accommodate objects of different sizes and shapes.

One example method for adapting automated handling equipment for different objects includes adjusting a position of a support member relative to an adapter support. The support member can be adjusted between positions to accommodate objects of different sizes and shapes.

The various features and advantages of this invention will become apparent to those skilled in the art from the following detailed description of a currently preferred embodiment. Drawings that accompany the detailed description can be briefly described as follows.

### BRIEF DESCRIPTION OF THE DRAWINGS

FIG. 1 illustrates a perspective view of an adapter assembly including a modular shovel.

FIG. 2A illustrates a perspective view showing the modular shovel before engagement with an object.

FIG. 2B illustrates a perspective view of the modular shovel of FIG. 2A in engagement with the object.

FIG. 3 illustrates a cross-sectional view of an example retainer member of a modular shovel having an opening that is non-concentric with a central axis of the retainer member.

FIG. 4A illustrates the adjustability of a retainer member relative to a plate.

FIG. 4B illustrates the adjustability of a retainer member according to the section line shown in FIG. 4A.

FIG. 5A illustrates a perspective view of an example plate having elongated openings.

FIG. 5B illustrates the adjustability of retainer members along the elongated openings of the plate shown in FIG. 5A.

FIG. 6A illustrates a perspective view of a backside of an example mount.

FIG. 6B illustrates a perspective view of a front side of the mount shown in FIG. 5A.

FIG. 7 illustrates the adjustability of a plate relative to a mount.

FIG. 8 illustrates an example embodiment having a modular shovel attached to an automated gripper.

### DETAILED DESCRIPTION OF THE PREFERRED EMBODIMENT

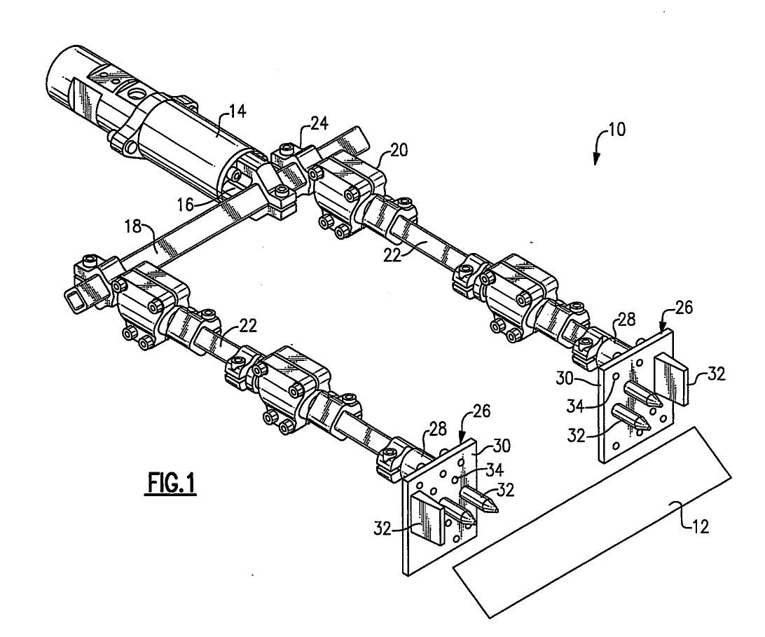

FIG. 1 illustrates an adapter assembly 10 for securely supporting an object 12 (shown schematically), such as a multi-dimensional metal work piece, during movement of the object 12. The adapter assembly 10 can be, for example, a robotic adapter or a transfer press assembly for moving the object 12 between various industrial presses or other machines.

In the illustrated example, the adapter assembly 10 includes an adapter 14 attached to an adapter joint 16, and the adapter joint 16 is attached to a rail 18. Although only one adapter 14 and adapter joint 16 are illustrated, it is to be understood that any number of adapters 14 and adapter joints 16 can be employed.

A series of ball jointed links 20 attach one or more shafts 22, or robotic members, to the rail 18 by a rail bracket 24. The ball jointed links 20 are positioned and secured in a desired position for the specific application. Alternatively, the shafts 22 are welded to the rail 18 or secured in a known manner.

In the illustrated example, a modular shovel 26 is attached to each of the distal ends of the shafts 22. Each of the modular shovels 26 includes a mount 28 for securing the modular shovel 26 to the shaft 22 and a plate 30 for receiving retainer members 32 that securely engage the object 12.

The plates 30 in this example include openings 34 for attaching the retainer members 32 in any of a variety of desired positions. That is, the retainer members 32 are removable to provide the benefit of a variety of modular shovel 26 configurations that can be tailored to different shapes and sizes of different objects 12. This eliminates the expense and need for custom-made shovels that are particular to a single object size and shape.

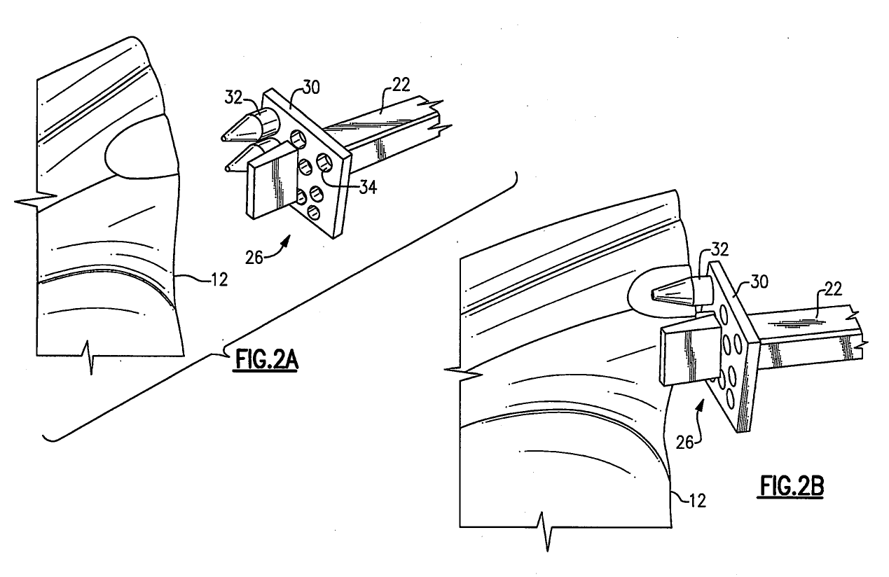

As an example of the operation of the modular shovel, FIG. 2A illustrates another view of the modular shovel 26 just before engagement with the object 12, and FIG. 2B shows the modular shovel 26 in engagement with the object 12. In the illustrated example, the modular shovel 26 is configured such that the object 12 fits securely between the retainer members 32 to support the object 12 when it is moved.

Referring to the example shown in FIG. 3, the retainer member 32 includes a central axis A along a length of the retainer member 32. In this example, the retainer member 32 includes a base portion 40 that tapers into a nose portion 42. The base portion 40 includes an opening 44 having an axis A′ that is non-concentric with the central axis A of the retainer member 32. The opening 44, such as a threaded opening, receives a fastener 47 through one of the openings 34 in the plate 30 to secure the retainer member 32 to the plate 30. Alternatively, the retainer member 32 has a different shape, such as rectangular (FIG. 1) or other desired shape. Given this description, one of ordinary skill in the art will recognize additional retainer member 32 shapes to meet their particular needs.

In this example, the base portion 40 also includes a surface 46 that engages the plate 30. The surface 46 includes teeth 48 that bite into the plate 30 to resist rotation of the retainer member 32 relative to the plate 30. This provides the benefit of a tight fit between the retainer member 32 and the plate 30.

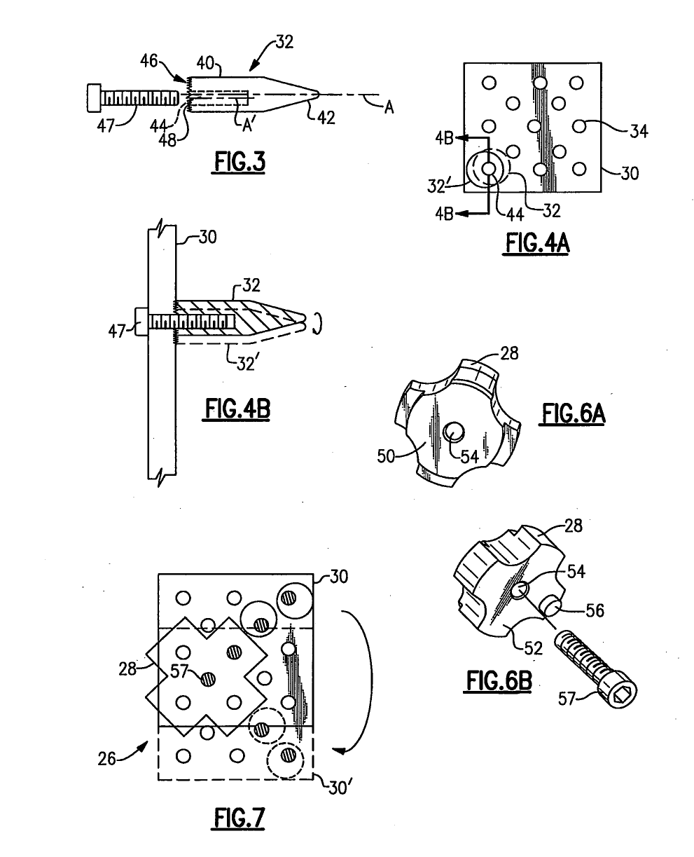

In the illustrated example, the axis A′ of the opening 44 is non-concentric with the central axis A of the retainer member 32. This provides the benefit of being able to adjust the position of the retainer member 32 by rotating the retainer member 32 about the axis A′, as shown in FIG. 4A (frontal view) and FIG. 4B (cross-sectional view), wherein the retainer member 32 is rotated to a position shown in phantom by the retainer member 32′. This provides the benefit of being able to fine tune the position of the retainer member 32 relative to the plate 30. Furthermore, the combination of this feature with the selection of openings 34 on the plate 30 provides a wide variety of possible modular shovel 26 configurations.

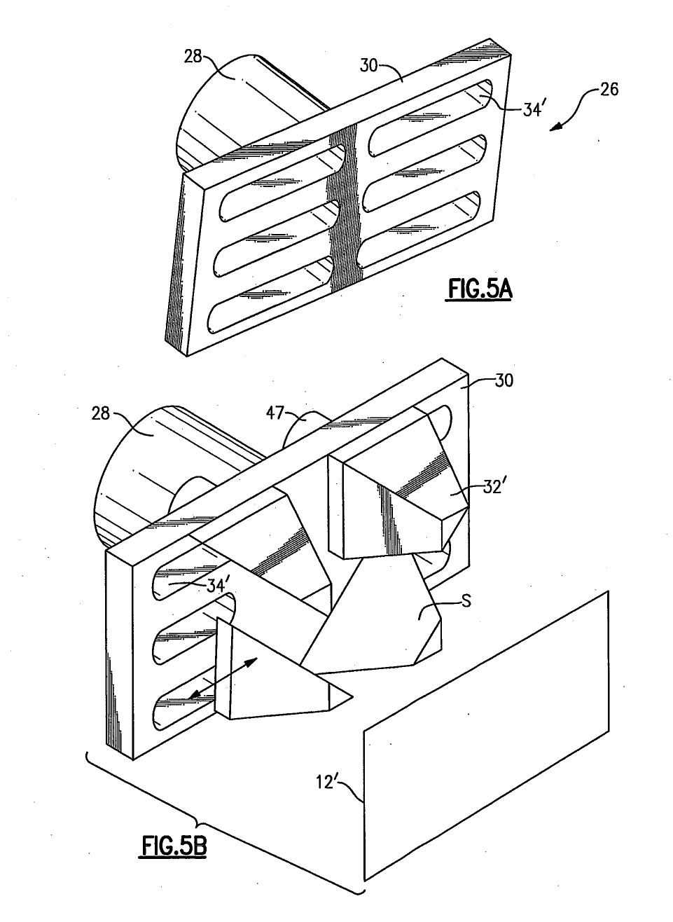

FIG. 5A illustrates a modified example in which the plate 30 includes elongated openings 34′ instead of the circular openings 34 shown in the previous example. As illustrated in FIG. 5B, the retainer members 32′ are secured to the plate 30 using fasteners 47, similar to as described above. In this example, the fasteners 47 may be loosened to slide the retainer member 32′ along the elongated opening 34′. The fasteners 47 are then tightened to secure the retainer members 32′ in desirable locations along the elongated openings 34′.

The retainer members 32′ in this example are also shaped differently than the retainer members 32 of the previous example. The retainer members 32′ include generally flat surfaces S for supporting an object 12′ (shown schematically) during movement. It is to be understood that the features of the disclosed examples may selectively be used in combination depending upon the needs of the particular application.

FIG. 6A (rear view) and FIG. 6B (front view) show an example mount 28. In this example, the mount 28 includes a back side 50 and a front side 52. The back side 50 connects to the shaft 22, such as by welding. A threaded opening 54 extends through the mount 28 for securing the plate 30 to the mount 28.

In the illustrated example, the front side 52 includes an anti-rotation pin 56 spaced from the opening 54. In one example, the distance between the opening 44 and the anti-rotation pin 56 corresponds to a spacing distance between at least some of the openings 34 in the plate 30.

When the plate 30 is attached to the mount 28, the anti-rotation pin 56 is received into a selected one of the openings 34, and the threaded opening 54 of the mount 28 aligns with an adjacent opening 34 to receive a fastener 57 for securing the mount 28 and the plate 30 together. The combination of the fastener 57 and the anti-rotation pin 56 prevent the plate 30 from rotating relative to the mount 28 and shaft 22. Given this description, one of ordinary skill in the art will recognize alternative mount 28 configurations and anti-rotation features.

Referring to FIG. 7, the mount 28 provides a variety of modular shovel 26 configurations. In this example, the fastener 57 is removed and the plate 30 is removed from the anti-rotation pin 56. The plate 30 is then rotated and re-installed onto the mount 28 in a different orientation shown in phantom by plate 30′. This provides the benefit of being able to quickly and easily tailor the orientation of the plate 30 for different sizes and shapes of different objects 12. Furthermore, this feature in combination with the non-concentric opening 44 of selected retainer members 32 and the selection of openings 34 in the plate 30 allows a large number of modular shovel 26 configurations.

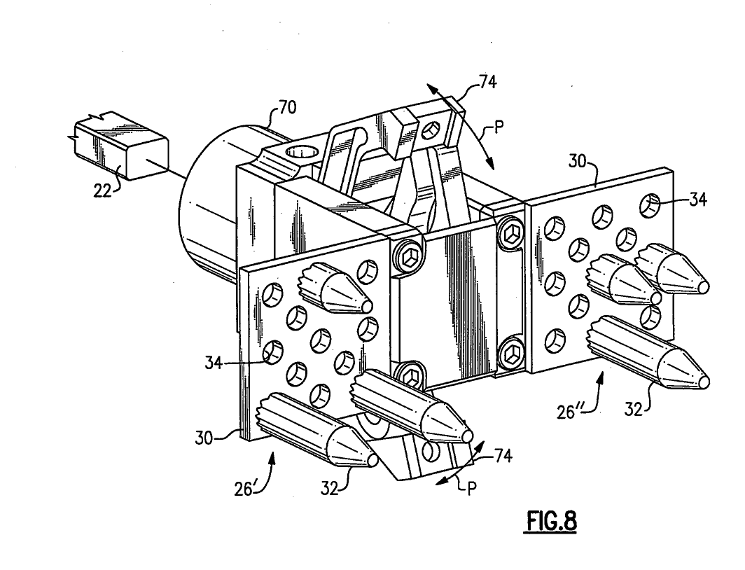

FIG. 8 shows another example, wherein two modular shovels 26′ and 26″ are secured to an automated gripper 70. The automated gripper 70 is attached to the shaft 22 (FIG. 1) or used in a known arrangement to receive and move the object 12. In this example, the automated gripper 70 includes an actuator 72, such as a fluid driven piston actuator or other known actuator, that pivots one or more jaws 74 along a pivot direction P for example.

In operation, the object 12 is received between the retainer members 32. The retainer members guide the object 12 into a desired, stable position. The actuator 72 then closes the jaws on the object 12 to retain the object 12 between the retainer members 32 during movement of the object 12. Utilizing the combination of the retainer members 32 to support the object and the automated gripper 70 to clamp and hold the object enables reliable transfer of the object between work stations or the like.

The foregoing description is exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention.

1. An adapter device for use in automated handling equipment, comprising:
an adapter support that is adapted for automated movement; and
at least one support member for supporting a work piece during movement of the work piece, wherein the support member is rigidly securable to the adapter support in a plurality of different positions relative to the adapter support, a portion of said plurality of different positions corresponding to different translational positions relative to the adapter support and another portion of said plurality of different positions corresponding to different rotational positions relative to the adapter support.

2. The device as recited in claim 1, wherein the adapter support includes at least one opening that extends at least partially into the adapter support for rigidly securing the at least one support member.

3. The device as recited in claim 2, wherein the at least one opening comprises an elongated slot.

4. The device as recited in claim 3, wherein the plurality of different positions comprises the at least one support member being rigidly securable at a plurality of locations along the elongated slot.

5. The device as recited in claim 2, wherein the at least one opening comprises a plurality of openings.

6. The device as recited in claim 5, wherein the different translational positions correspond to the at least one support member being rigidly securable to different ones of the plurality of openings.

7. The device as recited in claim 2, wherein the at least one support member includes a support member opening for receiving a fastener that extends through the at least one opening of the adapter support to secure the at least one support member to the adapter support.

8. The device as recited in claim 7, wherein the at least one support member includes a lock feature that resists relative rotational movement between the at least one support member and the adapter support.

9. The device as recited in claim 8, wherein the lock feature comprises teeth that engage at least one of the adapter support or the at least one of the support member to resist the movement.

10. The device as recited in claim 7, wherein the at least one support member comprises an elongated extension having a tapered end portion.

11. The device as recited in claim 10, wherein the adapter support comprises a plate.

12. The device as recited in claim 1, wherein the at least one support member defines a central axis and a non-central axis spaced from the central axis, and the at least one support member is rigidly securable along the non-central axis to the adapter support.

13. The device as recited in claim 1, wherein the different rotational positions correspond to the at least one support member being rotatable about the non-central axis between different angular positions.

14. The device as recited in claim 1, further comprising a robotic member connected to the adapter support for automatically moving the adapter support and the at least one support member.

15. The device as recited in claim 14, further comprising a mount having a first portion adapted for connection to the robotic member and a second portion adapted for connection to the adapter support.

16. The device as recited in claim 15, wherein at least one of the first portion or the second portion is rigidly securable to the corresponding one of the adapter support or robotic member in a plurality of different mount positions.

17. The device as recited in claim 16, wherein one of the mount or the adapter support includes at least one tab and the other of the mount or the adapter support includes a plurality of openings for receiving the at least one tab to provide the plurality of different mount positions.

18. The device as recited in claim 17, wherein the openings outnumber the tabs.

19. The device as recited in claim 17, wherein the at least one tab includes a pair of tabs that are received into corresponding ones of the plurality of openings to rotationally lock the mount and the adapter support.

20. The device is recited in claim 1, wherein the adapter support is fixed to an automated gripper having at least one actuated gripper jaw.

21. The device as recited in claim 20, wherein the automated gripper includes a pair of spaced-apart side walls between which the at least one actuated gripper jaw pivots, and the adapter support is fixed to at least one of the spaced-apart side walls.

22. A method for using the adapter device as recited in claim 1, comprising the step:
adjusting a position of the at least one support member relative to the adapter support between a first position and a second, different position.

23. The method as recited in claim 22, including the step of rotating the at least one support member between angular positions about a non-central axis of the at least one support member.

24. The method as recited in claim 22, including the step of moving the at least one support member from a first opening in the adapter support that corresponds to the first position to a second opening in the adapter support that corresponds to the second, different position.

25. The method as recited in claim 22, including the step of moving the at least one support member between the first position and the second, different position along an elongated slot.
